(19) United States
(12) Patent Application Publication
(10) Pub. No.: US 2026/0162577 A1
(43) Pub. Date: Jun. 11, 2026

(54) DISPLAY CONTROL METHOD AND DEVICE, AND DISPLAY DEVICE AND COMPUTER STORAGE MEDIUM

(71) Applicants: Beijing BOE Display Technology Co., Ltd., Beijing (CN); BOE Technology Group Co., Ltd., Beijing (CN)

(72) Inventors: Wei SUN, Beijing (CN); Shuhuan YU, Beijing (CN); Xin DUAN, Beijing (CN); Zhaoyun GU, Beijing (CN); Lianghao ZHANG, Beijing (CN); Yifan SONG, Beijing (CN); Mingming WANG, Beijing (CN); Zhengri LIN, Beijing (CN)

(21) Appl. No.: 18/703,818

(22) PCT Filed: Jul. 28, 2023
(86) PCT No.: PCT/CN2023/109988

§ 371 Date: Apr. 23, 2024

(30) Foreign Application Priority Data
Aug. 19, 2022 (CN) 202210997941.1

(51) Int. Cl. G09G 3/20; G06F 3/01

(52) U.S. Cl. CPC G09G 3/20; G06F 3/013; G09G 2330/02; G09G 2340/0435; G09G 2354/00

(57) ABSTRACT

Provided is a display control method. The method includes: determining a first display region of a display panel and a second display region outside the first display region; acquiring a row direction signal and a column direction signal; and by inputting the row direction signal into the row direction signal line and controlling, based on the column direction signal, the first switch, making the display panel drive the first display region at a first frequency and drive the second display region at a second frequency, wherein the first frequency is different from the second frequency.

### CROSS-REFERENCE TO RELATED APPLICATIONS

This application is a U.S. national stage of international application No. PCT/CN2023/109988, filed on Jul. 28, 2023, which claims priority to Chinese Patent Application No. 202210997941.1, filed on Aug. 19, 2022 and entitled “DISPLAY CONTROL METHOD AND DEVICE, DISPLAY DEVICE, AND COMPUTER STORAGE MEDIUM”, the disclosures of which are herein incorporated by reference in their entireties.

### TECHNICAL FIELD

The present disclosure relates to the field of display technologies, and in particular, relates to a display control method and device, a display device, and a computer storage medium.

### BACKGROUND

At present, with development of display technologies of modern display apparatuses, users' requirements for refresh rates of display systems increase constantly.

### SUMMARY

Embodiments of the present disclosure provide a display control method and device, a display device and a non-transitory computer storage medium. The technical solutions are as follows.

According to some embodiments of the present disclosure, a display control method is provided. The method is applicable to a display panel and the method includes: determining a first display region of the display panel and a second display region outside the first display region, wherein the display panel includes a plurality of sub-regions arranged in rows and columns and a plurality of first switches; each of the sub-regions includes at least one pixel unit; the first display region includes at least one of the sub-regions; and the second display region includes at least one of the sub-regions; acquiring a row direction signal and a column direction signal, wherein the column direction signal is configured to control on and off of the first switches in a column of the sub-regions; the pixel unit in the first display region corresponds to a row direction signal and a column direction signal that are of a first frequency; a frequency of at least one signal of a row direction signal and a column direction signal that correspond to the pixel unit in the second display region is a second frequency; the first frequency is different from the second frequency; the pixel unit is connected to a row direction signal line; the first switch is configured to control connection and disconnection of the row direction signal line; and the row direction signal line is configured to control communication and dis-communication of a drive signal of the pixel unit; and making the display panel drive the first display region at the first frequency and drive the second display region at the second frequency by inputting the row direction signal into the row direction signal line and controlling, based on the column direction signal, the first switch.

In some embodiments, the display panel further includes a column direction signal line, a second switch and a data line; each of the first switch and the second switch includes a control terminal, a first terminal and a second terminal; the first terminal and the second terminal are turned on or turned off under control of the control terminal; and the first terminal is a source and the second terminal is a drain; the control terminal of the first switch is electrically connected to the column direction signal line; the first terminal of the first switch is electrically connected to the row direction signal line and the second terminal of the first switch is electrically connected to the control terminal of the second switch; and the first terminal and the second terminal of the second switch are electrically connected to the data line; and the making the display panel drive the first display region at the first frequency and drive the second display region at the second frequency by inputting the row direction signal into the row direction signal line and controlling, based on the column direction signal, the first switch includes: in the first display region, making the row direction signal transmit to the second switch through the row direction signal line and the first switch sequentially by transmitting the column direction signal to the first switch at the first frequency by the column direction signal line; and in the second display region, making the row direction signal transmit to the second switch through the row direction signal line and the first switch sequentially by transmitting the column direction signal to the first switch at the second frequency by the column direction signal line.

In some embodiments, the display panel includes a human eye detecting assembly; and the determining the first display region of the display panel and the second display region outside the first display region includes: acquiring a stared region of a human eye watching the display panel by using the human eye detecting assembly; determining the first display region based on the stared region; and determining a region in the display panel and different from the first display region as the second display region.

In some embodiments, the acquiring the stared region of the human eye watching the display panel by using the human eye detecting assembly includes: acquiring a stared position of the human eye and the distance between a display surface of the display panel and the human eye watching the display panel by using the human eye detecting assembly; and generating the stared region based on the distance, the stared position and a predetermined human eye view field.

In some embodiments, the generating the stared region based on the distance, the stared position and the predetermined human eye view field includes: determining a horizontal coordinate of a target point on an edge of the stared region according to a first formula, wherein the first formula is X2=X1±Z×tan α; X2 is the horizontal coordinate of the target point on the edge of the stared region; X1 is the horizontal coordinate of the stared position; Z is the distance; and α is an angle that is half of the human eye view field; determining a vertical coordinate of the target point on the edge of the stared region according to a second formula, wherein the second formula is Y2=Y1±Z×tan α; Y2 is the vertical coordinate of the target point on the edge of the stared region; and Y1 is a vertical coordinate of the stared position; and generating the stared region based on horizontal coordinates and vertical coordinates of four target points on edges of the stared region.

In some embodiments, wherein the acquiring the stared region of the human eye watching the display panel by using the human eye detecting assembly comprises: in a case that a plurality of people watch a display panel, acquiring human eye information of the people by using the human eye detecting assembly; and selecting one piece of the human eye information of the people as default human eye information; and acquiring the stared region based on the default human eye information.

In some embodiments, the determining the first display region of the display panel and the second display region outside the first display region includes: detecting display data of a plurality of sub-regions in the display panel, wherein the display data includes a dynamic image and a static image; in response to detecting a dynamic image being within a sub-region, acquiring the first display region by determining the sub-region as the at least one sub-region in the first display region; and determining a region in the display panel and different from the first display region as the second display region, wherein a static image is within the second display region.

In some embodiments, the method further includes: determining a third display region of the display panel, wherein the third display region is between the first display region and the second display region; and making the display panel drive the third display region at a third frequency by controlling, based on the row direction signal and the column direction signal, the display panel, wherein the third frequency is less than the first frequency and greater than the second frequency.

In some embodiments, prior to making the display panel drive the first display region at the first frequency and drive the second display region at the second frequency by inputting the row direction signal into the row direction signal line and controlling, based on the column direction signal, the first switch, the method further includes: acquiring image data, wherein the image data is configured to control the display panel to display an image picture; rearranging the image data by processing the image data into a first drive signal corresponding to the first display region and a second drive signal corresponding to the second display region; and transmitting the first drive signal to the first display region at the first frequency; and outputting the second drive signal to the second display region at the second frequency.

According to some embodiments of the present disclosure, a display device is provided. The display device includes:
a control unit, wherein the control unit includes a control instruction generating unit, a time sequence processing unit and a driving unit that are electrically connected, wherein the control instruction generating unit is configured to generate a row digital signal and a column digital signal, transmit the row digital signal to the time sequence processing unit, and transmit the column digital signal to the driving unit; the time sequence processing unit is configured to receive the row digital signal, generate a row direction signal having a first frequency corresponding to a first display region, and generate a row direction signal having a second frequency corresponding to a second display region; and the driving unit is configured to receive the column digital signal, generate a column direction signal having the first frequency corresponding to the first display region, and generate a column direction signal having the second frequency corresponding to the second display region; and
a display panel, wherein the display panel is configured to receive the row direction signal and the column direction signal, and by inputting the row direction signal into the row direction signal line and controlling, based on the column direction signal, the first switch, drive the first display region at the first frequency and drive the second display region at the second frequency, wherein the first frequency is different from the second frequency; and
the display panel includes a plurality of sub-regions arranged in rows and columns and a plurality of first switches; the first switch is configured to control connection and disconnection of a row direction signal line of at least one column of the sub-regions; the first display region includes at least one of the sub-regions; and the second display region includes at least one of the sub-regions.

In some embodiments, the driving unit includes a time sequence control module, a voltage converting module and a power supply control module, wherein the time sequence control module is configured to receive the column digital signal, and output a time sequence control instruction; the power supply control module is configured to output a reference voltage; and the voltage converting module is configured to receive the time sequence control instruction, and convert the time sequence control instruction into the column direction signal based on the reference voltage, wherein the column direction signal is configured to drive a first switch in the first display region at the first frequency and drive a first switch in the second display region at the second frequency; and the voltage of the column direction signal ranges from 0V to 18V.

In some embodiments, the time sequence control instruction includes at least one pair of analog signals whose phases are opposite.

In some embodiments, the display panel further includes a row direction signal line, a column direction signal line, a data line, a second switch and a plurality of pixel units, wherein the first switch includes a first thin-film transistor; the second switch includes a second thin-film transistor; and each of the first thin-film transistor and the second thin-film transistor includes a gate, a source and a drain; and the gate of the first thin-film transistor is electrically connected to the column direction signal line; the source of the first thin-film transistor is electrically connected to the row direction signal line; the drain of the first thin-film transistor is electrically connected to the gate of the second thin-film transistor; the source of the second thin-film transistor is electrically connected to the data line; and the drain of the second thin-film transistor is electrically connected to the pixel unit.

In some embodiments, the display panel includes a human eye detecting assembly electrically, wherein the human eye detecting assembly is connected to the control unit; and the human eye detecting assembly is configured to: acquire a stared position of a human eye watching the display panel and a distance between the human eye and a display surface of the display panel; determine a horizontal coordinate of a target point on an edge of the stared region according to a first formula, wherein the first formula is X2=X1±Z×tan α; X2 is the horizontal coordinate of the target point on the edge of the stared region; X1 is a horizontal coordinate of the stared position; Z is the distance; and α is an angle that is half of the human eye view field; determine a vertical coordinate of the target point on the edge of the stared region according to a second formula, wherein the second formula is Y2=Y1±Z×tan α; Y2 is the vertical coordinate of the target point on the edge of the stared region; and Y1 is a vertical coordinate of the stared position; and generate the stared region based on horizontal coordinates and vertical coordinates of four target points on edges of the stared region.

According to some embodiments of the present disclosure, a display control device is provided. The display control device includes a processor and a memory, wherein the memory stores at least one instruction, at least one program, a code set or an instruction set; and wherein the processor, when loading and running the at least one instruction, the at least one program, the code set or the instruction set, is caused to perform the display control method as defined above.

According to some embodiments of the present disclosure, a non-transitory computer storage medium is provided. At least one instruction, at least one program, a code set or an instruction set in the non-transitory computer storage medium, when loaded and run by a processor, causes the processor to perform the display control method as defined above.

According to some embodiments of the present disclosure, a computer program product or a computer program is provided. The computer program product or the computer program includes a computer instruction stored in a non-transitory computer-readable storage medium. In a case that the computer instruction is read by a processor of a computer device from the non-transitory computer-readable storage medium and run by the processor, causes the computer device to perform the display control method as defined above.

### BRIEF DESCRIPTION OF DRAWINGS

For clearer illustration of the technical solutions in embodiments of the present disclosure, accompanying drawings required for describing the embodiments are briefly introduced hereinafter. It is apparent that the accompanying drawings described hereinafter merely illustrate some embodiments of the present disclosure, and those of ordinary skill in the art may derive other drawings from these accompanying drawings without creative efforts.

FIG. 1 is a flowchart of a display control method according to some embodiments of the present disclosure;

FIG. 2 is a schematic diagram of partitioned refreshing of a display panel according to some embodiments of the present disclosure;

FIG. 3 is a flowchart of another display control method according to some embodiments of the present disclosure;

FIG. 4 is a schematic diagram of determining a staring view field of a human eye according to some embodiments of the present disclosure;

FIG. 5 is a schematic top view of determining the staring view field of the human eye shown in FIG. 4;

FIG. 6 is a schematic diagram of partitions of a display panel according to some embodiments of the present disclosure;

FIG. 7 is a schematic diagram of a structure of a display device according to some embodiments of the present disclosure;

FIG. 8 is a schematic diagram of a structure of a driving circuit in a display panel according to some embodiments of the present disclosure;

FIG. 9 is a schematic diagram of a structure of a pixel driving circuit in the driving circuit shown in FIG. 8;

FIG. 10 is a schematic diagram of a structure of a driving unit of a display panel according to some embodiments of the present disclosure; and

FIG. 11 is a schematic diagram of a waveform of a column direction signal according to some embodiments of the present disclosure.

The explicit embodiments of the present disclosure are shown in above accompanying drawings, which will be described in detail hereinafter. These accompanying drawings and text descriptions are not intended to limit scope of concept of the present disclosure, but to illustrate the concept of the present disclosure to those of ordinary skill in the art with reference to specific embodiments.

### DETAILED DESCRIPTION

For clearer descriptions of the objectives, technical solutions, and advantages of the present disclosure, embodiments of the present disclosure are described in detail hereinafter with reference to the accompanying drawings.

In a display control method, a display panel improves an overall refresh rate of a display region of a display apparatus by receiving a row direction signal at a relatively high frequency, such that a more realistic picture display effect and a smoother video display effect are achieved, thereby improving users' experience. The row direction signal is configured to control, based on a time sequence, a scan drive circuit to drive a plurality of rows of pixels in the display panel.

In the above method, in the case that the refresh rate of the display panel is adjusted, flexibility of adjusting the refresh rate of the display panel is relatively poor due to a full-screen refresh rate adjustment.

First, an application scenario related to the embodiments of the present disclosure is described.

The display device includes a display panel and a driving apparatus. The display panel generally includes a row direction signal line (also referred to as a scanning line), a data line and a plurality of pixels. The driving apparatus includes a data driver and a scan driver. The display panel can display an image at a low frequency to reduce power consumption. For example, in a case that the display panel displays a static image, a refresh rate of the display panel is relatively low; and in a case that the display panel displays a video, the refresh rate of the display panel is relatively high.

The display panel includes a plurality of pixel units. Generally, in the case that the display panel displays a video, a relatively high refresh rate (also referred to as a driving frequency) is used to make video pictures change more smoothly. The refresh rate is also referred to as a screen refresh rate and represents a frequency at which displayed pictures are played in one second. The refresh rate is a driving frequency output in a signal of the data driver or the scan driver. For example, a refresh rate for driving the display panel is 60 Hz.

In some embodiments, an implementation environment includes a server and a display panel. The server includes a processor. A wired or wireless connection is established between the server and the display panel to make an image be displayed on the display panel.

FIG. 1 is a flowchart of a display control method according to some embodiments of the present disclosure. The method is applicable to a display panel in the implementation environment shown in FIG. 1. The method includes the following processes.

In 101, a first display region of the display panel and a second display region outside the first display region are determined.

The display panel includes a plurality of sub-regions arranged in rows and columns and a plurality of first switches. Each of the sub-regions includes at least one pixel unit. The first display region includes at least one of the sub-regions. The second display region includes at least one of the sub-regions.

In 102, a row direction signal and a column direction signal are acquired, wherein the column direction signal is configured to control on and off of first switches in a column of sub-regions; a pixel unit in the first display region corresponds to a row direction signal and a column direction signal that are of a first frequency; a frequency of at least one signal of a row direction signal and a column direction signal that correspond to a pixel unit in the second display region is a second frequency; and the first frequency is different from the second frequency.

For example, the first frequency is greater than or less than the second frequency.

The pixel unit is connected to a row direction signal line. The first switch is configured to control connection and disconnection of the row direction signal line. The row direction signal line is configured to control communication and dis-communication of a drive signal of the pixel unit.

In 103, the display panel is made to drive the first display region at the first frequency and drive the second display region at the second frequency by inputting the row direction signal into the row direction signal line and controlling, based on the column direction signal, the first switch.

In summary, the embodiments of the present disclosure provide a display control method. In the method, a display panel receives control signals to drive a first display region at a first frequency and drive a second display region at a second frequency, wherein the first frequency is different from the second frequency, that is, a refresh rate of the first display region in the display panel is different from a refresh rate of the second display region in the display panel. The control signals include a row direction signal and a column direction signal. In this way, the display panel can be partitioned refreshed, such that flexibility of adjusting a refreshing rate of display panel can be improved. This solves the problem in the related art that the flexibility of adjusting the refreshing rate of the display panel is relatively poor, thereby achieving an effect of flexibly adjusting the refresh rate of the display panel.

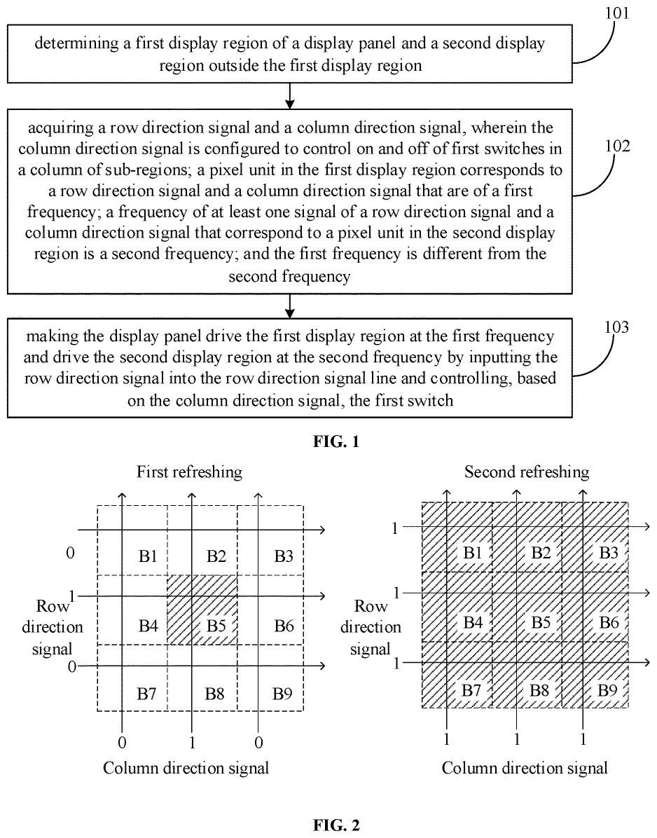

In some embodiments, FIG. 2 is a schematic diagram of partitioned refreshing of a display panel according to some embodiments of the present disclosure. Referring to FIG. 2, the display panel further includes a column direction signal line. The column direction signal line is configured to output a column direction signal. The display panel includes nine sub-regions. Each of the nine sub-regions is electrically connected to the row direction signal line and the column direction signal line. The nine sub-regions include a first sub-region B1, a second sub-region B2, a third sub-region B3, a fourth sub-region B4, a fifth sub-region B5, a sixth sub-region B6, a seventh sub-region B7, an eighth sub-region B8 and a ninth sub-region B9.

In a case that the row direction signal is 1, it indicates that an enabling signal is output. In a case that the row direction signal is 0, it indicates that no signal is output, or a disabling signal is output. Similarly, in the case that the column direction signal is 1, it indicates that an enabling signal is output; and in the case that the column direction signal is 0, it indicates that no signal is output, or a disabling signal is output. In a case that both a row direction signal and a column direction signal that correspond to a sub-region are 1, a drive signal of a pixel unit in the sub-region is communicated, that is, the sub-region can be driven to refresh. In a case that at least one of a row direction signal and a column direction signal that correspond to a sub-region is 0, a drive signal of a pixel unit in the sub-region is dis-communicated, that is, the sub-region cannot be driven to refresh.

FIG. 2 shows two refresh processes of the display panel. In a first refresh process, only a row direction signal and a column direction signal that correspond to the fifth sub-region B5 are both 1, and at least one of row direction signals and column direction signals that correspond to the other eight sub-regions is 0. In this case, only the fifth sub-region B5 can be driven to refresh in the first refresh process.

In a second refresh process, row direction signals and column direction signals that correspond to the nine sub-regions are all 1. In this case, all the nine sub-regions can be driven to refresh in the second refresh process. Therefore, a refresh rate of the fifth sub-region B5 is higher than refresh rates of the other eight sub-regions. That is, the fifth sub-region B5 can be the first display region, and the other eight sub-regions can be the second display regions. The fifth sub-region B5 can be driven at the first frequency, and the other eight sub-regions can be driven at the second frequency.

In the related art, there are the following two solutions for partitioned refreshing a display panel: Solution 1: Partitioned refreshing is performed on the display panel based on a row direction signal. Because the display panel is refreshed based on signals in one direction, the partitioned refreshing is performed on the display panel in only one direction (a row direction). As a result, the partitioned refreshing cannot be performed on the display panel in a column direction. Solution 2: Partitioned refreshing of the display panel in a column direction is achieved by dividing a plurality of pixel units in each row into a plurality of groups of pixel units, wherein the groups of pixel units are connected to a plurality of level shift chips respectively. Because a plurality of pixel units on the display panel are in a relatively large quantity of rows, such setting causes a problem that the quantity of level shift chips on the display panel is too large. As a result, a structure of the display panel is relatively complex. In the embodiments of the present disclosure, by controlling a display panel based on a row direction signal and a column direction signal, a first display region is driven at a first frequency and a second display region is driven at a second frequency. In this way, partitioned refreshing of the display panel can be achieved in a row direction and a column direction, and sizes of the first display region and the second display region can be adjusted flexibly. Therefore, the flexibility of adjusting a refreshing rate of display panel can be improved. In addition, there is no need to connect a relatively large quantity of level shift chips into the display panel, such that the structure of the display panel is relatively simple.

FIG. 3 is a flowchart of another display control method according to some embodiments of the present disclosure. The method is applicable to a display panel and the method includes the following processes.

In 201, a stared region of a human eye watching a display panel is acquired by using a human eye detecting assembly.

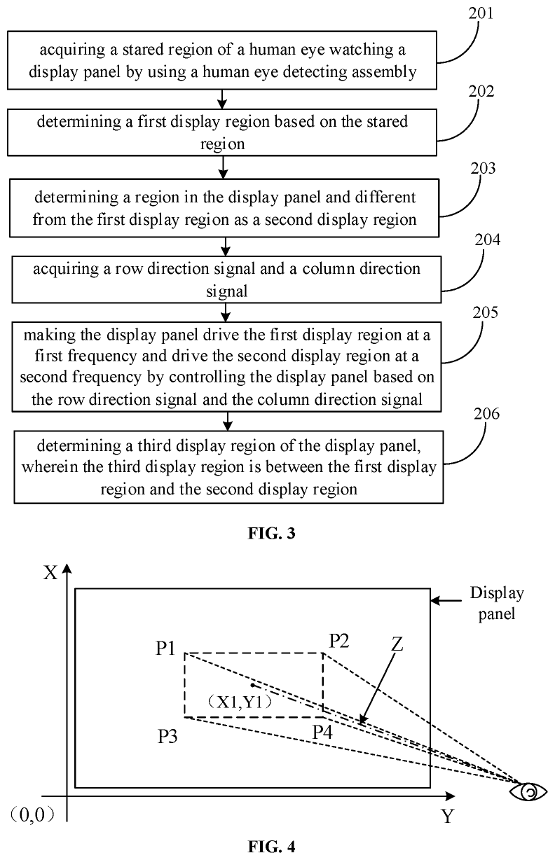

In some embodiments, the display panel includes the human eye detecting assembly. FIG. 4 is a schematic diagram of determining a staring view field of a human eye according to some embodiments of the present disclosure. Referring to FIG. 4, the human eye detecting assembly includes a camera and a human face detecting unit. The camera is configured to acquire a human face image of a person watching the display panel. The human face detecting unit is configured to extract human face information from the human face image acquired by the camera, and then detect human eye information. In some embodiments, a human eye detection control switch button is included in a display surface of the display panel, wherein the human eye detection control switch button is configured to enable or disable the human eye detecting assembly.

It should be noted that in a case that a user watches a display panel having a relatively large size, due to problems of a visual field of a human eye, a visual angle of the display panel and the size of a screen, ranges of the display panel that the user can see at different distances are different. Upon enabling the human eye detecting assembly, the display panel can acquire a distance between a human eye and the display surface of the display panel by using the human eye detecting assembly, or acquire a relative position and the distance between the human eye and the display surface of the display panel by using the human eye detecting assembly. In addition, a stared region of the human eye is acquired with reference to a visual characteristic of the human eye, namely, a comfortable view field of the human eye, thereby acquiring a watched region in which the user watches the display panel in a relatively comfortable state. In this way, a region on the display panel and corresponding to the stared region can be taken as the first display region, and the first display region is refreshed at a relatively high frequency, such that video pictures in the stared region of the user are relatively smooth.

In some embodiments, in a case that a plurality of people watch the display panel, human eye information of the people is acquired by using the human eye detecting assembly; and one piece of the human eye information of the people is selected as default human eye information. Information for adjusting a display region is acquired based on the default human eye information. That is, in the case that a plurality of people watch the display panel at the same time, one person is selected from the people; and information for adjusting the display region is acquired based on human eye information of the person.

In some embodiments, the acquiring the stared region of the human eye watching the display panel includes the following two processes.
(1) A stared position of the human eye and the distance between the display surface of the display panel and the human eye watching the display panel are acquired by using the human eye detecting assembly.

For example, the display panel shoots the human face image of the person watching the display panel by using the camera. The human face detecting unit acquires a human face region in the image based on the human face image, and performs facial landmark detection in the acquired human face region, wherein the facial landmark detection locates a feature point on the human face, such a corner of the mouth or a corner of an eye. Then, a first distance from the human face to the display surface of the display panel is acquired by using a perspective-n-point (PnP) algorithm. The first distance from the human face to the display surface of the display panel is taken as the distance between the human eye and the display surface of the display panel, such that a calculation amount is reduced. For example, the above distance is a vertical distance from the human eye to the display panel.

In some embodiments, the stared position of the human eye is acquired by using the camera to shoot the human face image of the person watching the display panel, acquiring a facial posture and the positions of pupils of the person based on the human face image, and acquiring the stared position of the human eye based on the facial posture and the positions of the pupils. For example, as shown in FIG. 4, a coordinate system is established by using a lower left corner of the display panel as an origin (0, 0). In the coordinate system, a horizontal axis is the X axis and a vertical axis is the Y axis. The acquired distance from the human eye to the display panel is Z, and coordinates of the stared position of the human eye are (X1, Y1).
(2) The stared region is generated based on the distance, the stared position and a predetermined human eye view field.

In some embodiments, the predetermined human eye view field is a staring range of the human eye at a predetermined angle. For example, the predetermined angle is an angle of a staring sight line of the human eye in a direction. In a case that the predetermined angle is not changed, different distances between the human eye and the display surface correspond to different sizes of stared regions of the human eye.

In some embodiments, the predetermined angle includes an angle of the staring sight line of the human eye in a horizontal direction and an angle of the staring sight line of the human eye in a vertical direction.

For example, the predetermined angles in the horizontal direction and the vertical direction are both 3°. The size of the staring view field of the human eye is determined based on the predetermined human eye view field (the predetermined angles) and the distance between the human eye and the display surface.

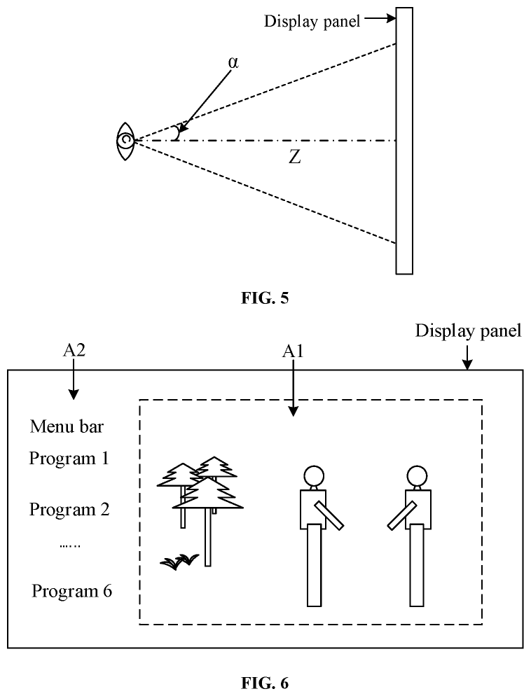

As shown in FIG. 5, FIG. 5 is a schematic top view of determining the staring view field of the human eye shown in FIG. 4. In a case that a display region of the display panel is a rectangle, a horizontal coordinate or a vertical coordinate of a target point on an edge of the stared region is calculated based on the distance Z and the predetermined angle, with the human eye taken as a center, a perpendicular line from the human eye to the display surface taken as a benchmark, and half of the predetermined angle as the angle α between the sight line of the human eye and the perpendicular line. In some embodiments, the shape of the stared region is a rectangle, wherein any side of the rectangle is parallel to a long edge or a short edge of the display region.

For example, the angle α between the sight line of the human eye and the perpendicular line from the human eye to the display surface ranges from 2.4° to 4°.

It should be noted that the predetermined angles in the horizontal direction and the vertical direction can be other values. For example, the predetermined angle in the horizontal direction is 3.5°, and the predetermined angle in the vertical direction is 2.5°, which are not limited in the embodiments of the present disclosure.

In some embodiments, the horizontal coordinate of the target point on the edge of the stared region is determined according to a first formula. The first formula is X2=X1±Z×tan α, wherein X2 is the horizontal coordinate of the target point on the edge of the stared region, X1 is the horizontal coordinate of the stared position, Z is the distance and α is an angle that is half of the human eye view field.

As shown in FIG. 4, target points on edges of the stared region include a first point P1, a second point P2, a third point P3 and a fourth point P4. The first point P1, the second point P2, the third point P3 and the fourth point P4 are four vertexes of a rectangular stared region. The horizontal coordinates of the first point P1 and the third point P3 are X2=X1−Z×tan α. The horizontal coordinates of the second point P2 and the fourth point P4 are X2=X1+Z×tan α.

In some embodiments, the vertical coordinate of the target point on the edge of the stared region is determined according to a second formula. The second formula is Y2=Y1+Z×tan α, wherein Y2 is the vertical coordinate of the target point on the edge of the stared region, and Y1 is the vertical coordinate of the stared position. Similarly, the vertical coordinates of the first point P1 and the second point P2 are Y2=Y1+Z×tan α, and the vertical coordinates of the third point P3 and the fourth point P4 are Y2=Y1−Z×tan α.

In this way, the stared region is generated based on the horizontal coordinates and the vertical coordinates of four target points on the edges of the stared region.

In some embodiments, in a case that a plurality of people watch the display panel, human eye information of the people is acquired by using the human eye detecting assembly; one piece of the human eye information of the people is selected as default human eye information by using the human eye detecting assembly; and the stared region is acquired based on the default human eye information by using the human eye detecting assembly. For example, in the human eye information of the people, human eye information of a person closest to a center of the image is determined as the default human eye information.

In 202, a first display region is determined based on the stared region.

In some embodiments, the display panel includes a plurality of sub-regions arranged in rows and columns. A sub-region of the sub-regions and in the stared region is determined by acquiring coordinates of the stared region. The sub-region in the stared region is determined as at least one sub-region in the first display region.

In 203, a region in the display panel and different from the first display region is determined as a second display region.

In some embodiments, the first display region includes at least one sub-region. The display panel further includes other sub-regions different from the at least one sub-region. The other sub-regions includes the second display region. That is, at least one sub-region outside the stared region is determined as the second display region. The second display region is a non-stared region. In this way, the first display region of the display panel and the second display region outside the first display region are determined, wherein the first display region includes at least one sub-region, and the second display region includes at least one sub-region.

In some embodiments, a plurality of sub-regions includes 6×20 sub-regions. That is, the display panel is divided into 20 partitions in a row direction, and is divided into 6 partitions in a column direction. For example, the first display region includes 60 sub-regions, and the second display region includes 60 sub-regions.

FIG. 6 is a schematic diagram of partitions of another display panel according to some embodiments of the present disclosure. Referring to FIG. 6, in some embodiments, a first display region A1 or a second display region A2 on the display panel are alternatively determined in the following manners. Or, upon performing the above process 201 to process 203, the size of the first display region A1 is relatively large, and a dynamic image and a static image are within the first display region A1. In this case, the range of the first display region A1 is further reduced.

In some embodiments, the method of determining the first display region A1 and the second display region A2 includes the following processes. First, display data of a plurality of sub-regions in the display panel is detected, wherein the display data includes a dynamic image and a static image. For example, the dynamic image includes a video, and the static image includes a menu bar, such as a program 1, a program 2 and the like.

Second, in response to detecting a dynamic image being within a sub-region, the first display region A1 is acquired by determining the sub-region as the at least one sub-region in the first display region A1. In some embodiments, a dynamic image and some static images are within the first display region A1. Then, a region in the display panel and different from the first display region A1 is determined as the second display region A2, wherein a static image is within the second display region A2.

In 204, a row direction signal and a column direction signal are acquired.

The column direction signal is configured to control on and off of first switches in at least one column of sub-regions.

In some embodiments, the display panel includes a plurality of sub-regions arranged in rows and columns and a plurality of first switches. The first switch is configured to control communication and dis-communication of a row direction signal of at least one column of sub-regions.

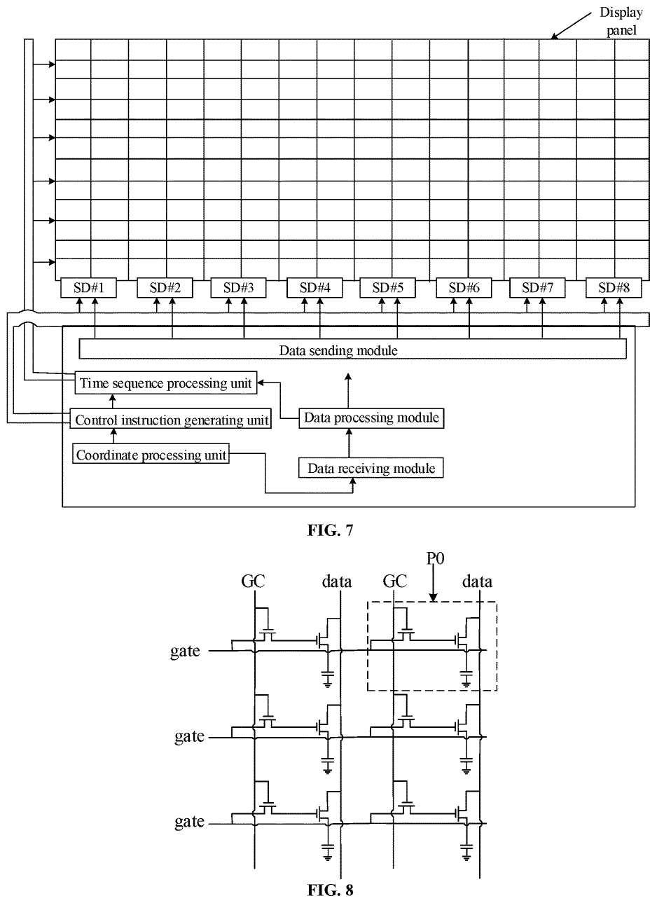

As shown in FIG. 7, FIG. 7 is a schematic diagram of a structure of a display device according to some embodiments of the present disclosure. The display device includes a control unit and a display panel. The control unit includes a control circuit board and driving units (SD #1 to SD #8 shown in FIG. 7). The control circuit board includes a coordinate processing unit, a control instruction generating unit, a time sequence processing unit, a driving unit, a data receiving module, a data processing module and a data sending module. The coordinate processing unit is configured to receive the stared position of the human eye watching the display panel and the distance between the human eye and the display surface of the display panel that are acquired in process 201, and determine the first display region and the second display region.

In some embodiments, based on the first display region and the second display region, the control instruction generating unit generates a row digital signal having the first frequency corresponding to the first display region, generates a row digital signal having the second frequency corresponding to the second display region, and transmits the signals to the time sequence processing unit. The time sequence processing unit receives the above row digital signals, converts the row digital signals into a row direction signal having the first frequency and a row direction signal having the second frequency, and transmits the row direction signal having the first frequency and the row direction signal having the second frequency to the first display region and the second display region respectively. Based on the first display region and the second display region, the control instruction generating unit further generates a column digital signal having the first frequency corresponding to the first display region, generates a column digital signal having the second frequency corresponding to the second display region, and transmits the signals to the driving unit. The driving unit receives the above column digital signals, convents the column digital signals into a column direction signal having the first frequency and a column direction signal having the second frequency, and transmits the column direction signal having the first frequency and the column direction signal having the second frequency to the first display region and the second display region respectively.

The data receiving module is configured to transmit a data/time sequence synchronizing signal to the time sequence processing unit based on the first display region and the second display region that are determined by the coordinate processing unit. The data processing module is electrically connected to the data receiving module, and the data processing module is configured to rearrange image data based on signals of the first display region and the second display region that are received by the data receiving module, and transmit the data/time sequence synchronizing signal to the time sequence processing unit, such that the time sequence processing unit outputs a row direction signal and a column direction signal at a transmission rate synchronized with the image data, thereby ensuring an accuracy of data reading in a case that the display panel displays an image. In addition, the data sending module transmits drive signals corresponding to the image data to the first display region and the second display region.

In some embodiments, the data processing module rearranging the image data includes the following processes. First, the image data is acquired, wherein the image data is configured to control the display panel to display an image picture. Second, the image data is processed into a first drive signal corresponding to the first display region and a second drive signal corresponding to the second display region, such that the image data is rearranged. Then, the first drive signal is transmitted to the first display region at the first frequency, and the second drive signal is output to the second display region at the second frequency. That is, the row direction signal and the column direction signal as well as the first drive signal and the second drive signal can be generated synchronously, and the display panel can be driven based on the above signals. For example, in unit time, the data processing module sends the first drive signal to the data sending module twice, and sends the second drive signal to the data sending module once.

In 205, by controlling the display panel based on the row direction signal and the column direction signal, the display panel is made to drive the first display region at a first frequency and drive the second display region at a second frequency.

In some embodiments, the first frequency is greater than the second frequency.

In this way, two display regions (the first display region and the second display region) on the display panel make the display panel drive the first display region at the first frequency, and drive the second display region at the second frequency based on control signals (the column direction signal and the row direction signal) that are output in two directions by time sequence. That is, the display panel receives control signals to drive the first display region at the first frequency and drive the second display region at the second frequency, wherein the first frequency is greater than the second frequency. The control signals include a row direction signal and a column direction signal. In this way, the display panel is partitioned refreshed, such that the power consumption of the display panel is reduced. The problem in the related art that the power consumption of a display panel is relatively large because the refresh rate of an entire screen is too high is solved, and an effect of reducing the power consumption of the display panel is achieved.

For example, a stared region of the human eye and a non-stared region of the human eye are refreshed at different frequencies, such that a pixel in a region that is on the display panel and does not need to be refreshed is kept. No data line is required to recharge a pixel electrode of a kept pixel, such that the power consumption of the display panel is reduced. Moreover, the kept pixel is free from interference of a signal generated by another refreshed pixel, such that the display effect of the display panel is improved while the power consumption of the display panel is reduced effectively.

In some embodiments, the first display region includes the stared region of the human eye. The display power consumption is reduced by refreshing the stared region of the human eye at a high frequency and refreshing the non-stared region of the human eye at a low frequency.

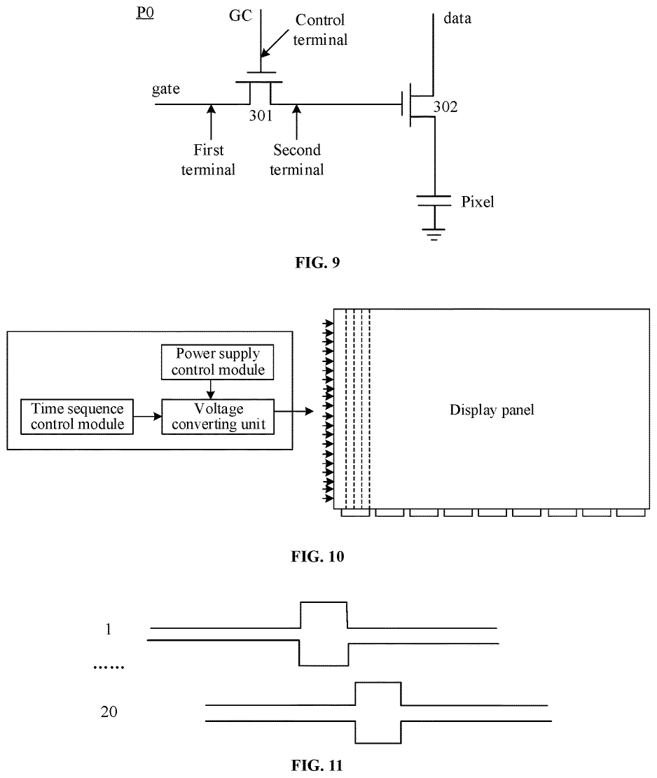

In some embodiments, as shown in FIG. 8 and FIG. 9, FIG. 8 is a schematic diagram of a structure of a driving circuit in a display panel according to some embodiments of the present disclosure; and FIG. 9 is a schematic diagram of a structure of a pixel driving circuit in the driving circuit shown in FIG. 8.

In some embodiments, the display panel further includes a row direction signal line (gate), a column direction signal line (gate control, GC), a second switch 302 and a data line (data). Both of first switch 301 and the second switch 302 include a control terminal, a first terminal and a second terminal. The first terminal and the second terminal are turned on or turned off under control of the control terminal. The control terminal of the first switch 301 is electrically connected to the column direction signal line (GC). The first terminal of the first switch 301 is electrically connected to the row direction signal line (gate), and the second terminal of the first switch 301 is electrically connected to the control terminal of the second switch 302. The first terminal and the second terminal of the second switch 302 are electrically connected to the data line (data).

In some embodiments, the column direction signal is transmitted to the first switch 301 through the column direction signal line (GC), and the column direction signal is configured to control on and off of a plurality of first switches 301 in a column of sub-regions. The first terminals of the plurality of first switches 301 in the column of sub-regions are electrically connected to a plurality of row direction signal lines (gates) respectively. A plurality of row direction signals are transmitted to the first terminals of the first switches 301 through the row direction signal lines (gate) respectively.

For example, in a case that the column direction signal is high, the first switches 301 are turned on to transmit the row direction signals to the control terminal of the second switch 302, such that the second switch 302 is turned on. Then, a drive signal is transmitted to a pixel (Cpixel) of the display panel, such that the pixel emits light. In this way, a pixel in at least one sub-region on the display panel can generate a row direction signal and a column direction signal based on a time sequence. Under the control (communication or dis-communication) of the two signals, pixels in the sub-regions on the display panel are controlled to display an image.

For example, as shown in FIG. 10, FIG. 10 is a schematic diagram of a structure of a driving unit of a display panel according to some embodiments of the present disclosure. The driving unit includes a time sequence control module, a voltage converting module and a power supply control module. The time sequence control module is configured to receive a column digital signal and output a time sequence control instruction. The power supply control module is configured to output a reference voltage. The voltage converting module is configured to receive the time sequence control instruction and convert the time sequence control instruction into the column direction signal (a voltage control signal) based on the reference voltage. The column direction signal is configured to drive the first switch in the first display region at the first frequency and drive the first switch in the second display region at the second frequency. The voltage of the column direction signal ranges from 0V to 18V.

In some embodiments, the control instruction generating unit outputs a 20-bit column digital signal according to an SPI protocol. The 20-bit column digital signal corresponds to driven (enabled/disabled) conditions of different sub-regions. For example, in a case that the signal is 0001 0000 0000 0000 0000, it indicates that in a refresh process of the display panel in this case, the fourth sub-region in a column direction is enabled, and a picture in this sub-region can be refreshed; and the other sub-regions are disabled, and pictures in these sub-regions cannot be refreshed. The time sequence control module receives the 20-bit column digital signal, and generates 20 time sequence control instructions (for example, the 20 time sequence control instructions include at least one pair of analog signals whose phases are opposite). In addition, the voltage converting module performs level shifting on the time sequence control instructions based on the reference voltage output by the power supply control module (the range of the level shifting is 0V to 18V, for example, a 1.8V time sequence control instruction is converted into an 18V voltage control signal). That is, the time sequence control instructions (analog signals) generated by the time sequence control module are converted into column direction signals (for example, the column direction signals are voltage control signals that range from 0V to 18V), such that the first switch is controlled.

As shown in FIG. 11, FIG. 11 is a schematic diagram of a waveform of a column direction signal according to some embodiments of the present disclosure. A column direction signal output by the driving unit includes at least one pair of analog signals whose phases are output oppositely, such that the driving unit is suitable for pixel driving circuits whose structures are different.

In this way, the display panel is controlled based on the row direction signal and the column direction signal, such that the display panel drives the first display region at the first frequency and drives the second display region at the second frequency.

For example, in the first display region, the column direction signal line transmits the column direction signal to the first switch at the first frequency, such that the row direction signal is transmitted to the second switch through the row direction signal line and the first switch sequentially; and then, a drive signal is transmitted to a pixel of the display panel, such that the pixel emits light.

In the second display region, the column direction signal line transmits the column direction signal to the first switch at the second frequency, such that the row direction signal is transmitted to the second switch through the row direction signal line and the first switch sequentially; and then, a drive signal is transmitted to a pixel of the display panel, such that the pixel emits light.

The first frequency and the second frequency are determined according to actual needs. For example, in a case that the first frequency is 120 Hz, the second frequency is 60 Hz, and in a case that the first frequency is 60 Hz, the second frequency is 30 Hz. In a case that the first frequency is as high as possible, the refresh rate of the stared region is as high as possible, such that an image displayed in the stared region is refreshed fast, and a delay phenomenon of the image in the stared region of the human eye can be alleviated. In a case that the second frequency is as low as possible, the power consumption of the display panel is reduced, such that a heat dissipation problem of the device caused by relatively high power consumption is solved, and user experience is improved.

For example, the refresh rate of the first display region is N times of the refresh rate of the second display region, wherein N is an integer greater than or equal to 1.

In some embodiments, the first display region and the second display region are driven by two driving units respectively. Or the first display region and the second display region are alternatively driven by a same driving unit.

In 206, a third display region of the display panel is determined, wherein the third display region is between the first display region and the second display region.

By controlling the display panel based on the row direction signal and the column direction signal, the display panel is made to drive the third display region at a third frequency, wherein the third frequency is less than the first frequency and greater than the second frequency.

Because the third display region whose refresh frequency is between the first frequency of the first display region and the second frequency of the second display region is disposed between the first display region and the second display region, a problem that power consumption is increased due to increase of a refresh frequency is alleviated while display quality is improved, and a problem that a human eye feels uncomfortable due to an abrupt spatial change of a refresh frequency is avoided.

In summary, the embodiments of the present disclosure provide a display control method. In the method, the display panel receives the control signals to drive the first display region at the first frequency and drive the second display region at the second frequency, wherein the first frequency is different from the second frequency, that is, the refresh rate of the first display region in the display panel is different from the refresh rate of the second display region in the display panel. The control signals include the row direction signal and the column direction signal. In this way, the display panel can be partitioned refreshed, such that the flexibility of adjusting the refreshing rate of the display panel can be improved. This solves the problem in the related art that the flexibility of adjusting the refreshing rate of the display panel is relatively poor, thereby achieving the effect of flexibly adjusting the refresh rate of the display panel.

In addition, a display control apparatus is provided in some embodiments of the present disclosure. The apparatus includes a display panel, a determining module, an acquiring module and a driving module.

The display panel includes a plurality of sub-regions arranged in rows and columns and a plurality of first switches, wherein each of the sub-regions includes at least one pixel unit. The pixel unit is connected to a row direction signal line, the first switch is configured to control connection and disconnection of the row direction signal line, and the row direction signal line is configured to control communication and dis-communication of a drive signal of the pixel unit.

The determining module is configured to determine a first display region of a display panel and a second display region outside the first display region, wherein the first display region includes at least one of the sub-regions, and the second display region includes at least one of the sub-regions.

The acquiring module is configured to acquire a row direction signal and a column direction signal. The column direction signal is configured to control on and off of first switches in a column of sub-regions. A pixel unit in the first display region corresponds to a row direction signal and a column direction signal that are of a first frequency. A frequency of at least one signal of a row direction signal and a column direction signal that correspond to a pixel unit in the second display region is a second frequency. The first frequency is different from the second frequency.

The driving module is configured to make the display panel drive the first display region at the first frequency and drive the second display region at the second frequency by inputting the row direction signal into a row direction signal line and controlling, based on the column direction signal, the first switch.

In addition, a display device is provided in some embodiments of the present disclosure. The display device includes a control unit and a display panel.

The control unit includes a control instruction generating unit, a time sequence processing unit, and a driving unit that are electrically connected. The control instruction generating unit is configured to generate a row digital signal and a column digital signal, transmit the row digital signal to the time sequence processing unit, and transmit the column digital signal to the driving unit. The time sequence processing unit is configured to receive the row digital signal, generate a row direction signal having a first frequency corresponding to a first display region, and generate a row direction signal having a second frequency corresponding to a second display region; and the driving unit is configured to receive the column digital signal, generate a column direction signal having the first frequency corresponding to the first display region, and generate a column direction signal having the second frequency corresponding to the second display region.

The display panel is configured to receive the row direction signal and the column direction signal, and by inputting the row direction signal into the row direction signal line and controlling, based on the column direction signal, the first switch, drive the first display region at the first frequency and drive the second display region at the second frequency, wherein the first frequency is different from the second frequency.

The display panel includes a plurality of sub-regions arranged in rows and columns and a plurality of first switches. The first switch is configured to control connection and disconnection of a row direction signal line of at least one column of the sub-regions. The first display region includes at least one of the sub-regions, and the second display region includes at least one of the sub-regions.

In some embodiments, the driving unit includes a time sequence control module, a voltage converting module and a power supply control module, wherein
the time sequence control module is configured to receive the column digital signal, and output a time sequence control instruction;
the power supply control module is configured to output a reference voltage; and
the voltage converting module is configured to receive the time sequence control instruction, and convert the time sequence control instruction into the column direction signal based on the reference voltage, wherein the column direction signal is configured to drive a first switch in the first display region at the first frequency and drive a first switch in the second display region at the second frequency; and the voltage of the column direction signal ranges from 0V to 18V.

In some embodiments, the display panel further includes a row direction signal line, a column direction signal line, a data line, a second switch and a plurality of pixel units, wherein the first switch includes a first thin-film transistor; the second switch includes a second thin-film transistor; and each of the first thin-film transistor and the second thin-film transistor includes a gate, a source and a drain; and
the gate of the first thin-film transistor is electrically connected to the column direction signal line; the source of the first thin-film transistor is electrically connected to the row direction signal line; the drain of the first thin-film transistor is electrically connected to the gate of the second thin-film transistor; the source of the second thin-film transistor is electrically connected to the data line; and the drain of the second thin-film transistor is electrically connected to the pixel unit.

In some embodiments, the first thin-film transistor and the second thin-film transistor are oxide transistors (for example, oxide thin-film transistors).

In some embodiments, the display panel includes a human eye detecting assembly, wherein the human eye detecting assembly is electrically connected to the control unit; and
the human eye detecting assembly is configured to:
acquire a stared position of a human eye watching the display panel and the distance between the human eye and a display surface of the display panel;
determine a horizontal coordinate of a target point on an edge of a stared region according to a first formula, wherein the first formula is X2=X1±Z×tan α; X2 is the horizontal coordinate of the target point on the edge of the stared region; X1 is the horizontal coordinate of the stared position; Z is the distance; and α is an angle that is half of a human eye view field;
determine a vertical coordinate of the target point on the edge of the stared region according to a second formula, wherein the second formula is Y2=Y1±Z×tan α; Y2 is the vertical coordinate of the target point on the edge of the stared region; and Y1 is the vertical coordinate of the stared position; and
generate the stared region based on the horizontal coordinates and the vertical coordinates of four target points on edges of the stared region.

In addition, a display control device is provided in some embodiments of the present disclosure. The display control device includes a processor and a memory, wherein the memory stores at least one instruction, at least one program, a code set or an instruction set; and wherein the processor, when loading and running the at least one instruction, the at least one program, the code set or the instruction set, is caused to perform the display control method as defined above.

In addition, a non-transitory computer storage medium is provided in some embodiments of the present disclosure. At least one instruction, at least one program, a code set or an instruction set in the non-transitory computer storage medium, when loaded and run by a processor, causes the processor to perform the display control method as defined above.

In addition, a computer program product or a computer program is provided in some embodiments of the present disclosure. The computer program product or the computer program includes a computer instruction stored in a non-transitory computer-readable storage medium. In a case that the computer instruction is read by a processor of a computer device from the non-transitory computer-readable storage medium and run by the processor, causes the computer device to perform the display control method as defined above.

In the present disclosure, the terms “first,” “second,” “third,” and “fourth” are only used for descriptive purposes and cannot be understood as indicating or implying relative importance. Unless otherwise defined, the term “a plurality of” refers to two or more.

In the embodiments of the present disclosure, it is understood that the disclosed apparatus and method can be implemented in other manners. For example, the apparatus embodiment described above is merely illustrative. For example, the unit division is merely logical function division. There may be another division manner during actual implementation. For example, a plurality of units or assemblies are combined or integrated into another system, or some features are ignored or not performed. In addition, the displayed or discussed mutual couplings or direct couplings or communication connections can be implemented by using some interfaces. The indirect couplings or communication connections between the apparatuses or units are implemented electrically, mechanically or in other forms.

The units described as separate components may or may not be physically separate, and components displayed as units may or may not be physical units, and may be located in one location, or may be distributed on a plurality of network units. Some or all of the units may be selected based on actual requirements to achieve the objectives of the solutions of the embodiments.

A person of ordinary skill in the art can understand that all or some of the processes of implementing the above embodiments can be completed by hardware, or can be completed by instructing related hardware by a program. The program can be stored in a non-transitory computer-readable storage medium. The above-mentioned storage medium may be a read-only memory, a magnetic disk, a compact disc or the like.

Described above are merely optional embodiments of the present disclosure, but are not intended to limit the present disclosure. Any modifications, equivalent replacements, improvements and the like made within the spirit and principle of the present disclosure shall be included within the protection scope of the present disclosure.

1. A display control method, wherein the method is applicable to a display panel and the method comprises:
determining a first display region of the display panel and a second display region outside the first display region, wherein the display panel comprises a plurality of sub-regions arranged in rows and columns and a plurality of first switches; each of the sub-regions comprises at least one pixel unit; the first display region comprises at least one of the sub-regions; and the second display region comprises at least one of the sub-regions;
acquiring a row direction signal and a column direction signal, wherein the column direction signal is configured to control on and off of first switches in a column of the sub-regions; the pixel unit in the first display region corresponds to a row direction signal and a column direction signal that are of a first frequency; a frequency of at least one signal of a row direction signal and a column direction signal that correspond to the pixel unit in the second display region is a second frequency; the first frequency is different from the second frequency; the pixel unit is connected to a row direction signal line; the first switch is configured to control connection and disconnection of the row direction signal line; and the row direction signal line is configured to control communication and dis-communication of a drive signal of the pixel unit; and
making the display panel drive the first display region at the first frequency and drive the second display region at the second frequency by inputting the row direction signal into the row direction signal line and controlling, based on the column direction signal, the first switch.

2. The method according to claim 1, wherein the display panel further comprises a column direction signal line, a second switch and a data line; each of the first switch and the second switch comprises a control terminal, a first terminal and a second terminal; the first terminal and the second terminal are turned on or turned off under control of the control terminal; the first terminal is a source and the second terminal is a drain;
the control terminal of the first switch is electrically connected to the column direction signal line; the first terminal of the first switch is electrically connected to the row direction signal line and the second terminal of the first switch is electrically connected to the control terminal of the second switch; and the first terminal and the second terminal of the second switch are electrically connected to the data line; and
the making the display panel drive the first display region at the first frequency and drive the second display region at the second frequency by inputting the row direction signal into the row direction signal line and controlling, based on the column direction signal, the first switch comprises:
in the first display region, making the row direction signal transmit to the second switch through the row direction signal line and the first switch sequentially by transmitting the column direction signal to the first switch at the first frequency by the column direction signal line; and
in the second display region, making the row direction signal transmit to the second switch through the row direction signal line and the first switch sequentially by transmitting the column direction signal to the first switch at the second frequency by the column direction signal line.

3. The method according to claim 1, wherein the display panel comprises a human eye detecting assembly; and the determining the first display region of the display panel and the second display region outside the first display region comprises:
acquiring a stared region of a human eye watching the display panel by using the human eye detecting assembly;
determining the first display region based on the stared region; and
determining a region in the display panel and different from the first display region as the second display region.

4. The method according to claim 3, wherein the acquiring the stared region of the human eye watching the display panel by using the human eye detecting assembly comprises:
acquiring a stared position of the human eye and a distance between a display surface of the display panel and the human eye watching the display panel by using the human eye detecting assembly; and
generating the stared region based on the distance, the stared position and a predetermined human eye view field.

5. The method according to claim 4, wherein the generating the stared region based on the distance, the stared position and the predetermined human eye view field comprises:
determining a horizontal coordinate of a target point on an edge of the stared region according to a first formula, wherein the first formula is X2=X1±Z×tan α; X2 is the horizontal coordinate of the target point on the edge of the stared region; X1 is a horizontal coordinate of the stared position; Z is the distance; and α is an angle that is half of the human eye view field;
determining a vertical coordinate of the target point on the edge of the stared region according to a second formula, wherein the second formula is Y2=Y1±Z×tan α; Y2 is the vertical coordinate of the target point on the edge of the stared region; and Y1 is a vertical coordinate of the stared position; and
generating the stared region based on horizontal coordinates and vertical coordinates of four target points on edges of the stared region.

6. The method according to claim 3, wherein the acquiring the stared region of the human eye watching the display panel by using the human eye detecting assembly comprises:
in a case that a plurality of people watch the display panel, acquiring human eye information of the people by using the human eye detecting assembly; and selecting one piece of the human eye information of the people as default human eye information; and
acquiring the stared region based on the default human eye information.

7. The method according to claim 1, wherein determining the first display region of the display panel and the second display region outside the first display region comprises:
detecting display data of a plurality of sub-regions in the display panel, wherein the display data comprises a dynamic image and a static image;
in response to detecting a dynamic image being within a sub-region, acquiring the first display region by determining the sub-region as the at least one sub-region in the first display region; and
determining a region in the display panel and different from the first display region as the second display region, wherein a static image is within the second display region.

8. The method according to claim 1, further comprising:
determining a third display region of the display panel, wherein the third display region is between the first display region and the second display region; and
making the display panel drive the third display region at a third frequency by controlling, based on the row direction signal and the column direction signal, the display panel, wherein the third frequency is less than the first frequency and greater than the second frequency.

9. The method according to claim 1, wherein prior to making the display panel drive the first display region at the first frequency and drive the second display region at the second frequency by inputting the row direction signal into the row direction signal line and controlling, based on the column direction signal, the first switch, the method further comprises:
acquiring image data, wherein the image data is configured to control the display panel to display an image picture;
rearranging the image data by processing the image data into a first drive signal corresponding to the first display region and a second drive signal corresponding to the second display region; and
transmitting the first drive signal to the first display region at the first frequency; and
outputting the second drive signal to the second display region at the second frequency.

10. A display device, comprising:
a control unit, wherein the control unit comprises a control instruction generating unit, a time sequence processing unit and a driving unit that are electrically connected, wherein the control instruction generating unit is configured to generate a row digital signal and a column digital signal, transmit the row digital signal to the time sequence processing unit, and transmit the column digital signal to the driving unit; the time sequence processing unit is configured to receive the row digital signal, generate a row direction signal having a first frequency corresponding to a first display region, and generate a row direction signal having a second frequency corresponding to a second display region; and the driving unit is configured to receive the column digital signal, generate a column direction signal having the first frequency corresponding to the first display region, and generate a column direction signal having the second frequency corresponding to the second display region; and
a display panel, wherein the display panel is configured to receive the row direction signal and the column direction signal, and by inputting the row direction signal into the row direction signal line and controlling, based on the column direction signal, the first switch, drive the first display region at the first frequency, and drive the second display region at the second frequency, wherein the first frequency is different from the second frequency; and
the display panel comprises a plurality of sub-regions arranged in rows and columns and a plurality of first switches; the first switch is configured to control connection and disconnection of a row direction signal line of at least one column of the sub-regions; the first display region comprises at least one of the sub-regions; and the second display region comprises at least one of the sub-regions.

11. The display device according to claim 10, wherein the driving unit comprises a time sequence control module, a voltage converting module and a power supply control module, wherein
the time sequence control module is configured to receive the column digital signal, and output a time sequence control instruction;
the power supply control module is configured to output a reference voltage; and
the voltage converting module is configured to receive the time sequence control instruction, and convert the time sequence control instruction into the column direction signal based on the reference voltage, wherein the column direction signal is configured to drive a first switch in the first display region at the first frequency and drive a first switch in the second display region at the second frequency; and a voltage of the column direction signal ranges from 0V to 18V.

12. The display device according to claim 10, wherein the display panel further comprises a row direction signal line, a column direction signal line, a data line, a second switch and a plurality of pixel units, wherein
the first switch comprises a first thin-film transistor; the second switch comprises a second thin-film transistor; and each of the first thin-film transistor and the second thin-film transistor comprises a gate, a source and a drain; and
the gate of the first thin-film transistor is electrically connected to the column direction signal line; the source of the first thin-film transistor is electrically connected to the row direction signal line; the drain of the first thin-film transistor is electrically connected to the gate of the second thin-film transistor; the source of the second thin-film transistor is electrically connected to the data line; and the drain of the second thin-film transistor is electrically connected to the pixel unit.

13. The display device according to claim 10, wherein the display panel comprises a human eye detecting assembly, wherein the human eye detecting assembly is electrically connected to the control unit; and
the human eye detecting assembly is configured to:
acquire a stared position of a human eye watching the display panel and a distance between the human eye and a display surface of the display panel;
determine a horizontal coordinate of a target point on an edge of the stared region according to a first formula, wherein the first formula is X2=X1±Z×tan α; X2 is the horizontal coordinate of the target point on the edge of the stared region; X1 is a horizontal coordinate of the stared position; Z is the distance; and α is an angle that is half of the human eye view field;
determine a vertical coordinate of the target point on the edge of the stared region according to a second formula, wherein the second formula is Y2=Y1±Z×tan α; Y2 is the vertical coordinate of the target point on the edge of the stared region; and Y1 is a vertical coordinate of the stared position; and
generate the stared region based on horizontal coordinates and vertical coordinates of four target points on edges of the stared region.

14. (canceled)

15. A non-transitory computer storage medium, wherein at least one instruction, at least one program, a code set or an instruction set in the non-transitory computer storage medium, when loaded and run by a processor, causes the processor to perform the display control method as defined in claim 1.

16. A display control device, comprising: a processor and a memory, wherein the memory stores at least one instruction, at least one program, a code set or an instruction set;
and wherein the processor, when loading and running the at least one instruction, the at least one program, the code set or the instruction set, is caused to perform:
determining a first display region of a display panel and a second display region outside the first display region, wherein the display panel comprises a plurality of sub-regions arranged in rows and columns and a plurality of first switches; each of the sub-regions comprises at least one pixel unit; the first display region comprises at least one of the sub-regions; and the second display region comprises at least one of the sub-regions;
acquiring a row direction signal and a column direction signal, wherein the column direction signal is configured to control on and off of first switches in a column of the sub-regions; the pixel unit in the first display region corresponds to a row direction signal and a column direction signal that are of a first frequency; a frequency of at least one signal of a row direction signal and a column direction signal that correspond to the pixel unit in the second display region is a second frequency; the first frequency is different from the second frequency; the pixel unit is connected to a row direction signal line; the first switch is configured to control connection and disconnection of the row direction signal line; and the row direction signal line is configured to control communication and dis-communication of a drive signal of the pixel unit; and
making the display panel drive the first display region at the first frequency and drive the second display region at the second frequency by inputting the row direction signal into the row direction signal line and controlling, based on the column direction signal, the first switch.

17. The display control device according to claim 16, wherein the display panel further comprises a column direction signal line, a second switch and a data line; each of the first switch and the second switch comprises a control terminal, a first terminal and a second terminal; the first terminal and the second terminal are turned on or turned off under control of the control terminal; the first terminal is a source and the second terminal is a drain;
the control terminal of the first switch is electrically connected to the column direction signal line; the first terminal of the first switch is electrically connected to the row direction signal line and the second terminal of the first switch is electrically connected to the control terminal of the second switch; and the first terminal and the second terminal of the second switch are electrically connected to the data line; and
the processor, when loading and running the at least one instruction, the at least one program, the code set or the instruction set, is caused to perform:
in the first display region, making the row direction signal transmit to the second switch through the row direction signal line and the first switch sequentially by transmitting the column direction signal to the first switch at the first frequency by the column direction signal line; and
in the second display region, making the row direction signal transmit to the second switch through the row direction signal line and the first switch sequentially by transmitting the column direction signal to the first switch at the second frequency by the column direction signal line.

18. The display control device according to claim 16, wherein the display panel comprises a human eye detecting assembly; and the processor, when loading and running the at least one instruction, the at least one program, the code set or the instruction set, is caused to perform:
acquiring a stared region of a human eye watching the display panel by using the human eye detecting assembly;
determining the first display region based on the stared region; and
determining a region in the display panel and different from the first display region as the second display region.

19. The display control device according to claim 18, wherein the processor, when loading and running the at least one instruction, the at least one program, the code set or the instruction set, is caused to perform:
acquiring a stared position of the human eye and a distance between a display surface of the display panel and the human eye watching the display panel by using the human eye detecting assembly; and
generating the stared region based on the distance, the stared position and a predetermined human eye view field.

20. The display control device according to claim 19, wherein the processor, when loading and running the at least one instruction, the at least one program, the code set or the instruction set, is caused to perform:
determining a horizontal coordinate of a target point on an edge of the stared region according to a first formula, wherein the first formula is X2=X1±Z×tan α; X2 is the horizontal coordinate of the target point on the edge of the stared region; X1 is a horizontal coordinate of the stared position; Z is the distance; and α is an angle that is half of the human eye view field;
determining a vertical coordinate of the target point on the edge of the stared region according to a second formula, wherein the second formula is Y2=Y1±Z×tan α; Y2 is the vertical coordinate of the target point on the edge of the stared region; and Y1 is a vertical coordinate of the stared position; and
generating the stared region based on horizontal coordinates and vertical coordinates of four target points on edges of the stared region.

21. The display control device according to claim 18, wherein the processor, when loading and running the at least one instruction, the at least one program, the code set or the instruction set, is caused to perform:
in a case that a plurality of people watch the display panel, acquiring human eye information of the people by using the human eye detecting assembly; and selecting one piece of the human eye information of the people as default human eye information; and
acquiring the stared region based on the default human eye information.
